(19) United States
(12) Patent Application Publication
(10) Pub. No.: US 2026/0114359 A1
(43) Pub. Date: Apr. 30, 2026

(54) Programmable Pesticidal/Fertilizer Irrigation Attachment System

(71) Applicant: John Campbell, Papillion, NE (US)

(72) Inventor: John Campbell, Papillion, NE (US)

(21) Appl. No.: 19/373,019

(22) Filed: Oct. 29, 2025

Related U.S. Application Data
(60) Provisional application No. 63/713,231, filed on Oct. 29, 2024.

(51) Int. Cl. A01C 23/04; A01C 23/00; A01M 7/00

(52) U.S. Cl. CPC A01C 23/042; A01C 23/007; A01M 7/0032; A01M 7/0089

(57) ABSTRACT

An irrigation attachment system for automated or autonomous delivery of lawn-treatment solutions through an existing sprinkler network is disclosed. The system includes an in-ground housing containing a refillable reservoir of concentrated pesticide or fertilizer, a mixing unit coupled downstream of a water supply line, and an electronic control unit programmed with a watering schedule and treatment concentration ratio. During operation, the mixing unit selectively withdraws treatment solution from the reservoir and outputs a treated water and solution mixture through sprinkler heads. The control unit includes memory for storing operational instructions, a processor to regulate dosing events in accordance with user-defined parameters, and a wireless communication module to interface with a mobile device. A day-of-week scheduling interface enables remote configuration of flow percentages and treatment add-in ratios. The system enables unattended irrigation and chemical dosing in a discreet, durable enclosure that integrates with conventional lawn-irrigation systems.

### CROSS-REFERENCE TO RELATED APPLICATION

The present application claims priority to, and the benefit of, U.S. Provisional Application No. 63/713,231 which was filed on Oct. 29, 2024, and is incorporated herein by reference in its entirety.

### FIELD OF THE INVENTION

The present invention generally relates to automated or autonomous irrigation accessories and lawn-treatment delivery systems. More specifically, the present invention relates to a pesticidal/fertilizer irrigation attachment configured to integrate with an existing sprinkler network and automatically (i.e., autonomously) dispense liquid pest-control or fertilizer solutions into the irrigation water flow. The invention comprises a ground-installed housing containing a refillable treatment reservoir, a mixing unit adapted to meter concentrated solution into pressurized water, and an embedded electronic control system for programmable, and remote control, operation. The mixing unit draws treatment solution via a supply conduit. The attachment is designed to provide uniform chemical distribution across lawn areas, reduce manual handling of pesticides and fertilizers, and enable remote scheduling and adjustment of treatment parameters via a smart-device interface. Accordingly, the present disclosure makes specific reference thereto. Nonetheless, it is to be appreciated that aspects of the present invention are also equally applicable to other like applications, devices, and methods of manufacture.

### BACKGROUND

By way of background, many individuals like maintaining a healthy, aesthetically appealing lawn. To achieve this, individuals mostly need to apply pesticide, herbicide, fertilizer, and other treatment solutions to control pests, weeds, fungi, and nutrient deficiencies. Traditional treatment methods require manual mixing and spraying using handheld applicators or hiring professional service contractors to perform monthly treatments. Professional lawn-care and pest-control services can be expensive and may apply chemicals at times that are inconvenient to the homeowner. Additionally, scheduling repeated visits or manually preparing and distributing treatments introduces variability in coverage, risks over-application or run-off, and requires the homeowner to handle potentially hazardous chemicals.

Existing in-ground irrigation systems provide a convenient way to distribute water throughout a lawn area; however, such systems generally lack the ability to automatically (i.e., autonomously) integrate chemical treatment solutions with the irrigation water flow. Accordingly, individuals desire an automated or autonomous attachment for standard irrigation systems that would enable treatment concentrates to be delivered to a lawn in a controlled and scheduled manner, without requiring constant manual handling by the homeowner.

Therefore, there exists a long-felt need in the art for an irrigation-based lawn-treatment apparatus that eliminates the need for homeowners to manually mix and apply pesticides and fertilizers. There is a long-standing need for a lawn-care device capable of automatically (i.e., autonomously) dispensing precise concentrations of chemical treatments directly through the existing sprinkler system. Further, there is a need in the art for a discreet, ground-level treatment system that is durable to resist damage from lawn equipment while providing scheduled, uniform application of pest-control solutions and nutrients. Additionally, there is a need for an irrigation attachment that integrates wireless programmable and remote controls, enabling users to remotely customize treatment ratios and watering schedules. Furthermore, there is a long-felt need for a lawn-treatment attachment that offers convenient, maintenance-free operation and reduces reliance on costly monthly pest-control services. Finally, there exists a need for an automated or autonomous irrigation accessory that provides consistent chemical coverage, minimizes waste, and improves long-term lawn health.

The subject matter disclosed and claimed herein, in one embodiment, comprises a pesticidal/fertilizer irrigation attachment system designed to connect directly to a homeowner's existing sprinkler line. The system includes a rugged in-ground housing configured to support internal components while remaining concealed at ground level. A concentrate reservoir is positioned inside the housing and is configured to hold liquid pesticide, fertilizer, or other lawn-treatment chemicals. A mixing unit is plumbed in line with the irrigation water supply and includes pumping or venturi-based components that selectively draw treatment concentrate from the reservoir and inject it into the passing water stream. An embedded electronic control unit is disposed within the housing and includes interface buttons for programming operational parameters and a display for indicating treatment concentration. The control unit wirelessly interfaces with a mobile application that enables the user to configure watering schedules, treatment ratios, and day-of-week selections from a remote smart device.

In one embodiment, the pesticidal/fertilizer irrigation attachment system utilizes a venturi injector. The venturi injector produces a pressure drop when irrigation water flows through the constricted throat, thereby inducing suction to draw treatment solution from the reservoir into the water stream.

In In this manner, the pesticidal/fertilizer irrigation attachment of the present invention addresses long-standing shortcomings in conventional lawn-care practices by automating chemical-treatment delivery, improving dosing accuracy, and using existing sprinkler systems to achieve widespread, uniform application. The invention enables users to maintain pest-free, nutrient-rich lawns without manual handling of chemical sprays or scheduling recurring service visits. By concealing the mechanism below ground and integrating wireless controls, the system offers a durable, user-friendly solution that promotes convenience, cost savings, and enhanced lawn health through consistent, scheduled irrigation and treatment dosing.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a pesticidal/fertilizer irrigation attachment system. The system comprises a housing configured for in-ground installation and defining an interior cavity. A chemical storage reservoir is arranged within the interior cavity and is configured to store a concentrated lawn treatment solution. A supply conduit extends from the chemical storage reservoir to a mixing unit. The mixing unit is positioned downstream of a pressurized irrigation water inlet and is configured to selectively withdraw the concentrated lawn treatment solution from the reservoir and inject the withdrawn solution into an irrigation water flow to form a treated mixture. An electronic control unit is disposed within the housing and electronically coupled to the mixing unit. The electronic control unit includes a wireless communication module, a memory, and a processor. The memory stores executable instructions that, when executed by the processor, cause the electronic control unit to receive user-defined inputs corresponding to a watering schedule and treatment concentration ratio and to control operation of the mixing unit accordingly. An irrigation water outlet is arranged downstream of the mixing unit and is configured to deliver the treated mixture to sprinkler heads of a lawn-irrigation system.

In another embodiment, a home irrigation system attachment is disclosed. The attachment includes a weather-resistant housing configured to be buried substantially flush with a ground surface. A removable chemical storage reservoir is positioned within the housing and includes a threaded cap to enable replenishment of concentrate. A mixing unit includes pumping components operable to draw liquid concentrate from the chemical storage reservoir and introduce the concentrate into the water supply pipe. An electronically programmable control unit is disposed in the housing and is programmed to store, in a memory, control instructions governing timed activation of the mixing unit. The control unit further includes a wireless communication interface configured to communicate with a smart device and receive remotely configuration data relating to watering duration, selected days of operation, water flow percentage, treatment add-in percentage.

In one embodiment, the mixing device is fluidly connected to a water supply inlet and is configured to meter chemical concentrate from the reservoir into irrigation water flowing through the inlet. A user interface visually displays operational information including irrigation mode, time remaining, water flow percentage, treatment add-in percentage, and enables the user to select days of the week on which automated or autonomous irrigation and dosing should occur.

In yet another embodiment, a method of delivering a pesticidal/fertilizer irrigation treatment using a pesticidal/fertilizer irrigation attachment system is provided. The method includes installing a housing in-ground adjacent to a water supply line of an existing irrigation system and positioning a chemical storage reservoir and a mixing unit inside the housing. The method further includes supplying irrigation water through an inlet into the mixing unit and automatically (i.e., autonomously) drawing a concentrated lawn treatment solution from the chemical storage reservoir through a supply conduit into the mixing unit. The concentrated lawn treatment solution is mixed with the irrigation water to form a treated mixture. The method also includes wirelessly (i.e., remotely) receiving user-defined instructions at an electronic control unit, the instructions including a watering schedule, a treatment add-in percentage, and a desired treatment concentration ratio. The electronic control unit is programmed to selectively activate the mixing unit to withdraw and inject the concentrated lawn treatment solution according to the treatment concentration ratio and watering schedule. During operation, the treated mixture is delivered from the housing to sprinkler heads of the irrigation system, and the treated mixture is discharged over a lawn area in accordance with the watering schedule.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates an isometric view of pesticidal/fertilizer irrigation attachment system of the present invention in accordance with the disclosed structure;

FIG. 2 depicts a schematic block diagram of the embedded electronic control unit of the pesticidal/fertilizer irrigation system of the present invention in accordance with the disclosed structure;

FIG. 3 illustrates an exemplary user interface displayed on a smart mobile device for remotely controlling and monitoring operation of the pesticidal/fertilizer irrigation system of the present invention;

FIG. 4 provides an external perspective view of the pesticidal/fertilizer irrigation system in accordance with the disclosed structure;

FIG. 5 illustrates a flowchart showing an exemplary method of operation of the pesticidal/fertilizer irrigation system of the present invention in accordance with the disclosed structure; and

FIG. 6 illustrates a perspective view of a venturi injector assembly installed in the irrigation flow path of the pesticidal/fertilizer irrigation system of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an irrigation-based lawn-treatment apparatus that eliminates the need for homeowners to manually mix and apply pesticides and fertilizers. There is a long-standing need for a lawn-care device capable of automatically (i.e., autonomously) dispensing precise concentrations of chemical treatments directly through the existing sprinkler system. Further, there is a need in the art for a discreet, ground-level treatment system that is durable to resist damage from lawn equipment while providing scheduled, uniform application of pest-control solutions and nutrients. Additionally, there is a need for an irrigation attachment that integrates wireless programmable (i.e., remote) controls, enabling users to remotely customize treatment ratios and watering schedules. Furthermore, there is a long-felt need for a lawn-treatment attachment that offers convenient, maintenance-free operation and reduces reliance on costly monthly pest-control services. Finally, there exists a need for an automated or autonomous irrigation accessory that provides consistent chemical coverage, minimizes waste, and improves long-term lawn health.

The present invention, in one exemplary embodiment, is a home irrigation system attachment. The attachment includes a weather-resistant housing configured to be buried substantially flush with a ground surface. A removable chemical storage reservoir is positioned within the housing and includes a threaded cap to enable replenishment of concentrate. A mixing unit includes pumping components operable to draw liquid concentrate from the chemical storage reservoir and introduce the concentrate into the water supply pipe. An electronically programmable control unit is disposed in the housing and is programmed to store, in a memory, control instructions governing timed activation of the mixing unit. The control unit further includes a wireless communication interface configured to communicate with a smart device and remotely receive configuration data relating to watering duration, selected days of operation, and treatment add-in percentage.

Reference will now be made in detail to the present preferred embodiments of the invention, examples of which are illustrated in the accompanying drawings. Wherever possible, the same reference numerals are used in the drawings and the description to refer to the same or like parts.

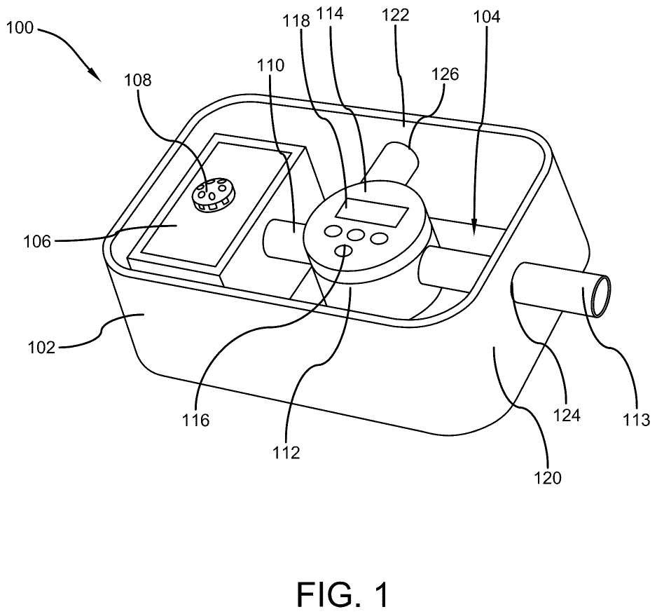

Referring initially to the drawings, FIG. 1 illustrates an isometric view of pesticidal/fertilizer irrigation attachment system of the present invention in accordance with the disclosed structure. The pesticidal/fertilizer irrigation attachment system 100 of the present invention is designed as an integrated pest-control irrigation attachment that connects directly to a homeowner's existing sprinkler or lawn-irrigation system. The pesticidal/fertilizer irrigation attachment system 100 is configured to automatically (i.e., autonomously) dose and mix liquid pest control, liquid fertilizer, or other lawn-treatment chemicals with the irrigation water, and to distribute the mixture through the standard sprinkler network.

More specifically, the pesticidal/fertilizer irrigation attachment system 100 includes a generally rectangular weather-resistant housing 102, configured for in-ground installation such as adjacent to a conventional sprinkler water line. The housing 102 defines an interior cavity 104 that supports internal system components from weather, foot traffic, and lawn-maintenance equipment while remaining substantially unseen from aboveground. The housing 102 is rugged and discreet and is buried at ground-level like traditional irrigation control boxes.

A chemical storage reservoir 106 is positioned in the housing 102 and is configured to store a concentrated lawn treatment solution such as pesticide or fertilizer. The chemical storage reservoir 106 has a removable threaded cap 108, enabling a user to replenish fluid as needed. A supply conduit 110 extends from the reservoir 106 and within the cavity 104, wherein the supply conduit 110 is fluidly connected to a mixing unit 112 for mixing the pesticide or fertilizer and water. In the preferred embodiment, the reservoir 106 is at least a 3-gallon sealed reservoir.

The mixing unit 112 is positioned downstream of the pressurized water supply line inlet 113 and is configured to house a plurality of pumping components for selectively withdrawing the concentrate solution from reservoir 106 and injecting the withdrawn solution into the passing water stream. An embedded electronic control unit 114 is electronically coupled to the mixing unit 112 and includes a plurality of push-buttons 116 for programming and operating the system 100 such as for receiving user-defined inputs relating to at least a watering schedule and a treatment concentration ratio. A user-interface display 118 is included in the embedded control unit 114 and displays the programmed mixing level of the concentrated solution.

The housing defines an inlet 124 and an outlet 126 in the walls 120, 122 of the housing 102, thereby forming a flow path through which irrigation water passes. During operation, the concentrated treatment solution is selectively metered from reservoir 106 into the incoming water stream (through the water supply line inlet 113) within the mixing unit 112 and then exits toward downstream sprinkler heads.

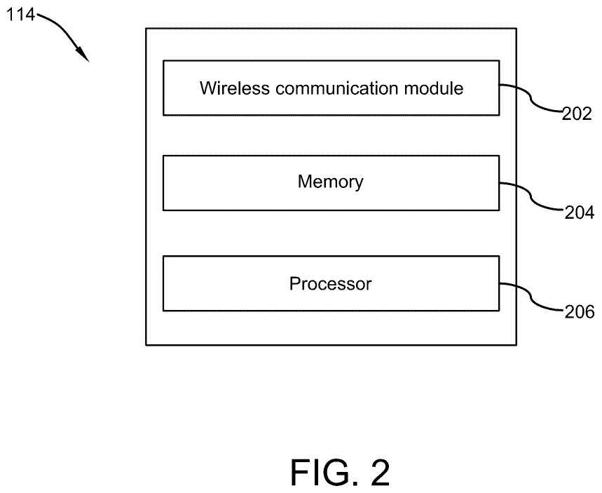

FIG. 2 depicts a schematic block diagram of the embedded electronic control unit 114 of the pesticidal/fertilizer irrigation system of the present invention in accordance with the disclosed structure. A wireless communication module 202 is embedded in the electronic control unit 114 and is configured to establish a wireless communication channel to remotely transmit and receive data from a remote device such as a smartphone (i.e., a phone app). The wireless communication module 202 may establish a long-range or short-range communication channel such as Wi-Fi, Bluetooth, Zigbee, or cellular, thereby enabling remote configuration and monitoring of the system 100.

The memory 204 of the electronic control unit 114 is preferably a non-transitory, computer-readable storage medium, and may comprise one or more components such as flash memory, EEPROM, solid-state drive (SSD), RAM, or other suitable semiconductor storage devices. The memory 204 is configured to store executable control instructions and operational data used by the processor 206 to perform the dosing and irrigation functions of the system 100. The memory 204 may store control instructions which govern the timed activation of the mixing unit for delivering the concentrated treatment solution (i.e., add-in percentage) into the irrigation water stream. The memory 204 also stores user-defined values such as desired chemical concentration ratios, add-in percentage, maximum allowable injection volumes, water flow rate targets, reservoir capacity data, and acceptable dosage limits for specific treatment solutions.

The processor 206 is operatively connected to the memory 204 and executes the instructions stored therein to control activation of the mixing unit, regulate the injection rate of liquid concentrate from the storage reservoir based upon a predefined treatment ratio, and communicate operational status through the wireless communication module 202.

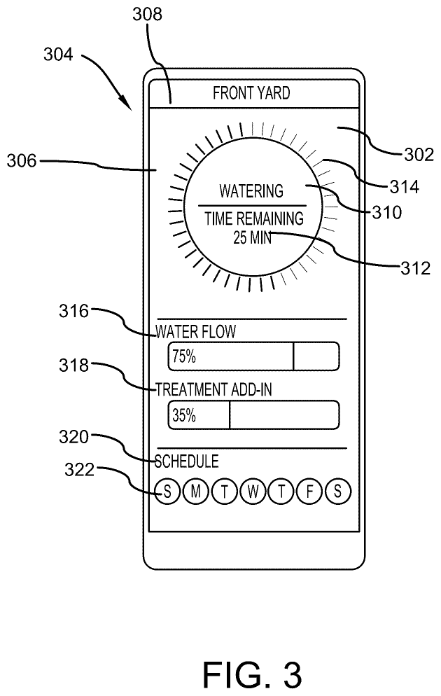

FIG. 3 illustrates an exemplary user interface displayed on a smart mobile device for remotely controlling and monitoring operation of the pesticidal/fertilizer irrigation system of the present invention. The system 100 includes a software application 302 which enables a user to remotely control and configure the operational parameters of the system 100. The software application 302 is installed on an electronic computing device 304 and is configured to display at least one user interface 306.

The user interface 306 displays a header region 308 identifying the active irrigation zone (i.e., FRONT YARD). It should be noted that the application 302 can be connected to a plurality of pesticidal/fertilizer irrigation systems and each system 100 can be identified using a unique name. A status indicator 310 displays the current mode of operation (such as watering) along with a countdown timer indicating a remaining irrigation time 312. The status indicator 310 also includes radial tick marks 314 to provide a visual cue of progression through the watering cycle.

The user interface 306 includes a first slider control 316 exemplary labeled WATER FLOW, which enables user adjustment and display of a desired water flow percentage relative to full pressure (such as at approximately 75%). A second slider control 318, labeled TREATMENT ADD-IN, enables the user to set the concentration percentage of treatment solution to be mixed with irrigation water (shown exemplary at approximately 35%). The concentration percentage can be established as a ratio of treatment solution to water. For example, 1 part treatment solution to 4 parts water equates to 1:4 ratio.

A schedule-selection region 320 is a graphical, day-of-the-week interface and comprises a horizontally arranged row of a plurality of selectable icons or buttons 322, each corresponding to a respective day of the week. The buttons are configured to be toggled on or off by the user to schedule treatment/watering to run on a particular day. The region 320 enables weekly-recurrence scheduling directly from the mobile interface by enabling the user to activate any combination of days. The selections made in region 320 are transmitted to the electronic control unit 114 for storage in the memory 204 and are used by the processor 206 to determine on which days to initiate automatic irrigation and dosing operations. In some embodiments, each day button may optionally support long-press or double-tap functions to further specify multiple watering times per day or skip weeks.

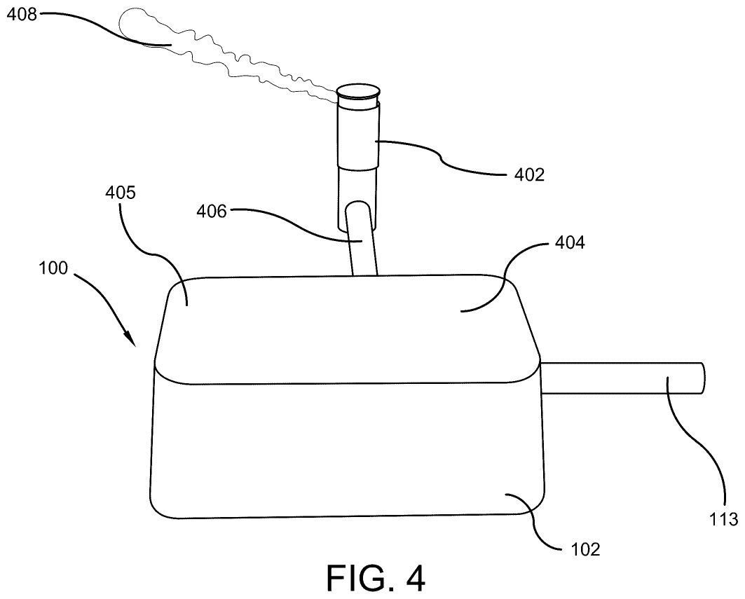

FIG. 4 provides an external perspective view of the pesticidal/fertilizer irrigation system in accordance with the disclosed structure. As shown, the ground-level housing 102 can be covered by a removable lid 404. The lid 404 has a textured or patterned top surface 405 to blend with surrounding landscaping and flushes with the ground surface to enable lawn equipment to pass over without interference. The inlet pipe 113 carries pressurized water through the internal mixing unit 112 (FIG. 1) housed within the housing 102. A sprinkler head 402 is coupled to the system 100 via an intermediate connecting conduit 406. During an active irrigation cycle, the sprinkler head 402 emits a spray pattern 408, which comprises a mixture of water and selectively dosed treatment solution (from the reservoir 106 of FIG. 1), if the associated mixing unit 112 inside the housing 102 releases chemical from the internal reservoir 106.

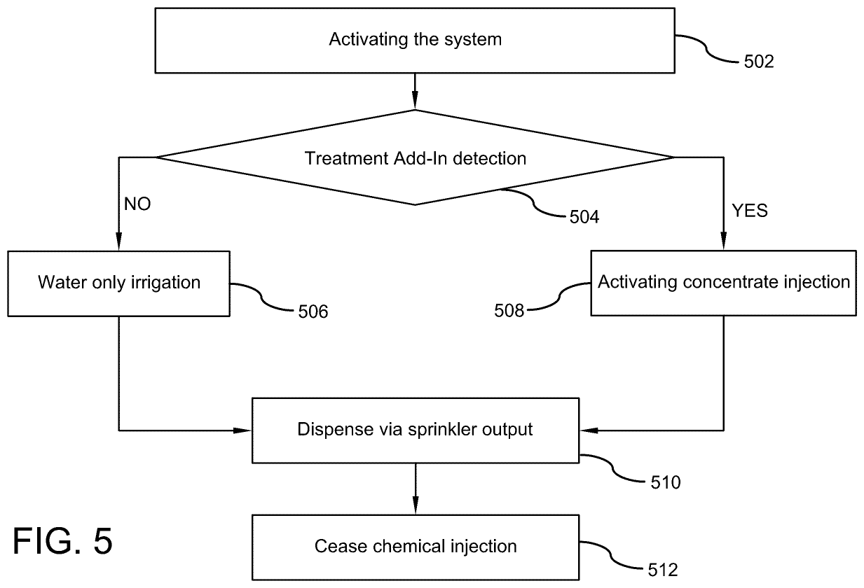

FIG. 5 illustrates a flowchart showing an exemplary method of operation of the pesticidal/fertilizer irrigation system of the present invention in accordance with the disclosed structure. Initially, the system 100 is activated, which may occur based on a preset schedule (as shown in FIG. 3), a manual command given to the control unit 114, or receipt of a wireless remote start signal from the corresponding mobile software application (Step 502).

Upon system activation, the control unit 114 determines whether chemical treatment dosing is scheduled for the current irrigation cycle (Step 504). The control unit 114 makes the determination in real-time and accordingly, if the result of decision is NO, the process proceeds to a water-only irrigation (Step 506), wherein untreated water is allowed to flow through the system 100 and onto the lawn. If the result of decision step is YES, the process advances to an activating concentrate injection (Step 508), in which a predetermined volume of the liquid concentrate from the storage tank reservoir is withdrawn and is introduced into the irrigation water flow at a predetermined rate and/or ratio.

Following either irrigation mode (step 506 or step 508), the blended or plain water is dispensed to the lawn via sprinkler heads (Step 510). After the completion of the scheduled run time, the system 100 executes a cease chemical injection (Step 512), thereby terminating the dosing and/or irrigation operation and returning the system 100 to standby status until the next activation event.

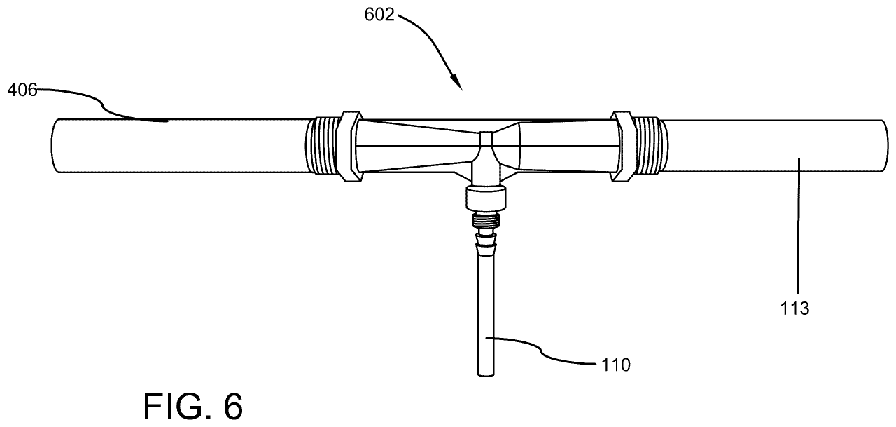

FIG. 6 illustrates a perspective view of a venturi injector assembly installed in the irrigation flow path of the pesticidal/fertilizer irrigation system of the present invention in accordance with the disclosed structure. The primary water pipe 113 is shown entering the venturi injector from one side, while the outlet pipe 406 carries fluid away from the injector toward downstream sprinkler heads. The injector 602 has a constricted throat region configured to accelerate the incoming water flow, thereby generating a localized pressure drop. The supply conduit 110, which extends toward the chemical storage reservoir (not shown in this figure) draws treatment solution from the reservoir upward through conduit 110 to mix into the flowing water stream.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “automated or autonomous pesticidal/fertilizer irrigation attachment system”, “programmable lawn treatment dispensing system”, “pesticidal/fertilizer irrigation attachment system”, and “system” are interchangeable and refer to the programmable pesticidal/fertilizer irrigation attachment system 100 of the present invention.

Notwithstanding the forgoing, the programmable pesticidal/fertilizer irrigation attachment system 100 of the present invention can be of any suitable configuration as is known in the art without affecting the overall concept of the invention, provided that it accomplishes the above stated objectives. One of ordinary skill in the art will appreciate that the programmable pesticidal/fertilizer irrigation attachment system 100 as shown in the FIGS. are for illustrative purposes only, and that many other configurations of the programmable pesticidal/fertilizer irrigation attachment system 100 are well within the scope of the present disclosure. Although the dimensions of the programmable pesticidal/fertilizer irrigation attachment system 100 are important design parameters for user convenience, the programmable pesticidal/fertilizer irrigation attachment system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A lawn-irrigation attachment system comprising:
a housing;
a chemical storage reservoir;
a concentrated lawn treatment solution;
a mixing unit;
a supply conduit; and
a sprinkler network;
wherein said chemical storage reservoir comprises a removable cap enabling a user to replenish said concentrated lawn treatment solution;
wherein said supply conduit extends from said chemical storage reservoir and is fluidly connected to said mixing unit for mixing said concentrated lawn treatment solution and water; and
further wherein said mixing unit fluidly connected to said sprinkler network for distributing a mixture of said concentrated lawn treatment solution and water through said sprinkler network.

2. The lawn-irrigation attachment system of claim 1, wherein said distributing said concentrated lawn treatment is autonomously dosed through said sprinkler network.

3. The lawn-irrigation attachment system of claim 1, wherein said concentrated lawn treatment solution selected from the group consisting of a liquid pest control and a liquid fertilizer.

4. The lawn-irrigation attachment system of claim 1, wherein said chemical storage reservoir is positioned in said housing and is configured to store said concentrated lawn treatment solution.

5. The lawn-irrigation attachment system of claim 1, wherein said supply conduit is fluidly connected to said mixing unit for mixing said mixture of said concentrated lawn treatment solution and the water.

6. The lawn-irrigation attachment system of claim 5 further comprising a pressurized water supply line inlet, wherein said mixing unit is positioned downstream of said pressurized water supply line inlet and is configured to house a plurality of pumping components for selectively withdrawing said concentrated lawn treatment solution from said chemical storage reservoir and injecting the withdrawn said concentrated lawn treatment solution into a passing water stream.

7. The lawn-irrigation attachment system of claim 6 further comprising an electronic control unit electronically coupled to said mixing unit, wherein said electronic control unit comprises a plurality of push-buttons for programming and operating the lawn-irrigation attachment system for receiving user-defined inputs selected from the group consisting of a watering schedule, a treatment concentration ratio, a desired chemical concentration ratio, a maximum allowable injection volume, a water flow rate target, a reservoir capacity data, an acceptable dosage limit for specific treatment solutions, and an identification of an active irrigation zone.

8. The lawn-irrigation attachment system of claim 7 further comprising a user-interface display embedded in said electronic control unit to display a programmed mixing level of said concentrated lawn treatment solution.

9. A lawn-irrigation attachment system comprising:
a housing;
a chemical storage reservoir;
a concentrated lawn treatment solution;
a mixing unit;
a supply conduit;
a sprinkler network;
an electronic control unit; and
a wireless communication module;
wherein said chemical storage reservoir comprises a removable cap enabling a user to replenish said concentrated lawn treatment solution;
wherein said supply conduit extends from said chemical storage reservoir and is fluidly connected to said mixing unit for mixing said concentrated lawn treatment solution and water;
wherein said mixing unit fluidly connected to said sprinkler network for distributing a mixture of said concentrated lawn treatment solution and water through said sprinkler network;
wherein said electronic control unit electronically coupled to said mixing unit;
wherein said electronic control unit comprises a plurality of push-buttons for programming and operating the lawn-irrigation attachment system for receiving user-defined inputs selected from the group consisting of a watering schedule, a treatment concentration ratio, a desired chemical concentration ratio, a maximum allowable injection volume, a water flow rate target, a reservoir capacity data, an acceptable dosage limit for specific treatment solutions, and an identification of an active irrigation zone; and
further wherein said wireless communication module is embedded in a remote said electronic control unit and is configured to establish a wireless communication channel to remotely transmit and receive data from said remote said electronic control unit to remotely operate the lawn-irrigation attachment system.

10. The lawn-irrigation attachment system of claim 9, wherein said distributing said concentrated lawn treatment is autonomously dosed through said sprinkler network.

11. The lawn-irrigation attachment system of claim 9, wherein said concentrated lawn treatment solution selected from the group consisting of a liquid pest control and a liquid fertilizer.

12. The lawn-irrigation attachment system of claim 9, wherein said chemical storage reservoir is positioned in said housing and is configured to store said concentrated lawn treatment solution.

13. The lawn-irrigation attachment system of claim 9, wherein said supply conduit is fluidly connected to said mixing unit for mixing said mixture of said concentrated lawn treatment solution and the water.

14. The lawn-irrigation attachment system of claim 9 further comprising a pressurized water supply line inlet, wherein said mixing unit is positioned downstream of said pressurized water supply line inlet and is configured to house a plurality of pumping components for selectively withdrawing said concentrated lawn treatment solution from said chemical storage reservoir and injecting the withdrawn said concentrated lawn treatment solution into a passing water stream.

15. The lawn-irrigation attachment system of claim 9 further comprising a user-interface display embedded in said electronic control unit to display a programmed mixing level of said concentrated lawn treatment solution.

16. A method of augmenting a lawn-irrigation system, the method comprising the steps of:
providing a housing, a chemical storage reservoir, a concentrated lawn treatment solution, a mixing unit, a supply conduit, a sprinkler network, an electronic control unit, and a wireless communication module, wherein said supply conduit extends from said chemical storage reservoir and is fluidly connected to said mixing unit for mixing said concentrated lawn treatment solution and water;
fluidly connecting said mixing unit to said sprinkler network for distributing a mixture of said concentrated lawn treatment solution and water through said sprinkler network, wherein said electronic control unit electronically coupled to said mixing unit; and
programming said electronic control unit with a plurality of push-buttons for operating the lawn-irrigation attachment system to receive user-defined inputs selected from the group consisting of a watering schedule, a treatment concentration ratio, a desired chemical concentration ratio, a maximum allowable injection volume, a water flow rate target, a reservoir capacity data, an acceptable dosage limit for specific treatment solutions, and an identification of an active irrigation zone, wherein said wireless communication module is embedded in said electronic control unit and is configured to establish a wireless communication channel to transmit and receive data from a remote said electronic control unit to operate the lawn-irrigation system.

17. The method of augmenting a lawn-irrigation system of claim 16 further comprising a step of autonomously dosing said distributing of said concentrated lawn treatment solution through said sprinkler network.

18. The method of augmenting a lawn-irrigation system of claim 16, wherein said concentrated lawn treatment solution selected from the group consisting of a liquid pest control and a liquid fertilizer.

19. The method of augmenting a lawn-irrigation system of claim 16, wherein said supply conduit is fluidly connected to said mixing unit for mixing said mixture of said concentrated lawn treatment solution and the water.

20. The method of augmenting a lawn-irrigation system of claim 16 further comprising a pressurized water supply line inlet, wherein said mixing unit is positioned downstream of said pressurized water supply line inlet and is configured to house a plurality of pumping components for selectively withdrawing said concentrated lawn treatment solution from said chemical storage reservoir and injecting the withdrawn said concentrated lawn treatment solution into a passing water stream.
